(19) United States
(12) Patent Application Publication
(10) Pub. No.: US 2007/0118633 A1
(43) Pub. Date: May 24, 2007

(54) Cluster command testing

(76) Inventors: C.P. Vijay Kumar, Cupertino, CA (US); Douglas K. Eldred, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/271,064

(22) Filed: Nov. 10, 2005

(51) Int. Cl. G06F 15/173

(52) U.S. Cl. 709/223

(57) ABSTRACT

Systems, methods, and devices are provided for testing commands in a cluster environment. One embodiment includes saving an original system state of two or more targeted cluster members by invoking a first operation with a testing tool and automatically testing the system states of the two or more targeted cluster members on which a command is run.

### BACKGROUND

In a computing device, such as a server, router, desktop computer, laptop, etc., and other devices having processor logic and memory, the device includes an operating system and a number of application programs that execute on the computing device. The operating system layer includes a “kernel”. The kernel is a master control program that runs the computing device. The kernel provides functions such as task, device, and data management, among others. The application layer includes application programs that perform particular tasks. These programs can typically be added by a user or administrator as options to a computer device. Application programs are executable instructions, which are located above the operating system layer and accessible by a user.

The application layer and other user accessible layers are often referred to as being in “user space”, while the operating system layer can be referred to as “kernel space”. As used herein, “user space” implies a layer of code which is more easily accessible to a user or administrator than the layer of code which is in the operating system layer or “kernel space”. “User space” code also can have lesser privileges than “kernel space” code, both hardware and software.

In an operating system parlance, the kernel is the set of modules forming the core of the operating system. The kernel is loaded into main memory first on startup of a computer and remains in main memory providing services such as memory management, process and task management, and disk management. The kernel also handles such issues as startup and initialization of the computer system. Logically, a kernel configuration is a collection of all the administrator choices and settings needed to determine the behavior and capabilities of the kernel. This collection includes a set of kernel modules (each with a desired state), a set of kernel tunable parameter value assignments, a primary swap device, a set of dump device specifications, a set of bindings of devices to other device drivers, a name and optional description of the kernel configuration, etc.

A computer cluster is a type of distributed computing system commonly used to perform parallel tasks with physically distributed computers. Cluster members, referred to as nodes, may include one or more processors, memory, and interface circuitry and can exchange data between members. The cluster nodes can be coupled to shared storage devices, e.g., disk arrays or other distributed shared memory as is understood by those in the art. A cluster environment may include two or more nodes. Various types of cluster environments exist, including high availability (HA) clusters, load balancing clusters, and high performance clusters, among others. Such cluster systems may be used to improve efficiency by splitting computing tasks among the various nodes, to provide reliability via backup nodes, and for various other purposes as are understood by those in the art.

System users, e.g., system administrators, may dynamically change kernel configurations of cluster systems by using cluster-capable commands. Kernel configuration tools, e.g., software that can execute commands, can be used to alter the configurations of multiple cluster members from a remote cluster member. Various configuration commands, or tools, are known in the art.

The ability to change cluster configurations is useful to maintain system functionality. The process of configuring an operating system kernel, i.e., kernel configuration, has some possibility for error, potentially leaving a system unstable or unusable. Therefore, it is useful to test kernel configuration commands to determine if resulting changes are suitable.

The current methods use a test infrastructure that knows how to run an existing test, which was written for a single system, on all cluster members and then record the results for each member. Using the current methods can involve writing new test code using the current test infrastructure. The new test code, written in the syntax provided by current test infrastructure, would then invoke an existing test.

Even if new test code using the new syntax is written, the new test code may not provide fine-grained control over individual steps within an existing test case (e.g., saving, running, and restoring). Control over the individual steps within a test case using existing tests and test infrastructure is useful for testing commands within a cluster environment. In addition, the test programmer needs to learn the new syntax of the new test infrastructure to adapt existing test cases into a cluster environment.

### BRIEF DESCRIPTION OF THE DRAWINGS

FIG. 1 is a block diagram of a computer cluster system suitable to implement embodiments of the present disclosure.

FIG. 2 illustrates code functionality according to an embodiment of the present disclosure.

FIG. 3 is a flow chart illustrating a method of testing kernel configuration tools according to an embodiment of the present disclosure.

FIG. 4 illustrates an approach to performing a processing method according to an embodiment of the present disclosure.

FIG. 5 illustrates an approach to performing a processing method according to an embodiment of the present disclosure.

### DETAILED DESCRIPTION

Automating tests for commands in a cluster environment involves saving system states of cluster members targeted for an operation, running a command on the targeted members, and restoring the system states of the targeted members. Embodiments of the present disclosure describe a testing tool for testing KC (kernel configuration) tools in a cluster environment. According to various embodiments, a kcexec tool is described which uses a fan-out method for cluster-capable KC commands. The cluster-capable KC commands use a remote invocation infrastructure provided by the cluster infrastructure encapsulated in a KC library to make kernel configuration changes on targeted members regardless of whether the members are up or down. For down members, this involves treating the command as an alternate root mode operation with the mount path of the boot directory of the down member as the alternate root location. According to various embodiments, a kcexec tool is described which uses the remote command invocation infrastructure to set up and restore the system states of cluster members before and after a test. By changing the KC test suite so that all set up and restore operations (calls to Unix commands, e.g., cp (copy), mv (move), rm (remove), symlink (create symbolic link), etc.) are invoked via the kcexec tool, the numerous existing tests were made cluster-capable.

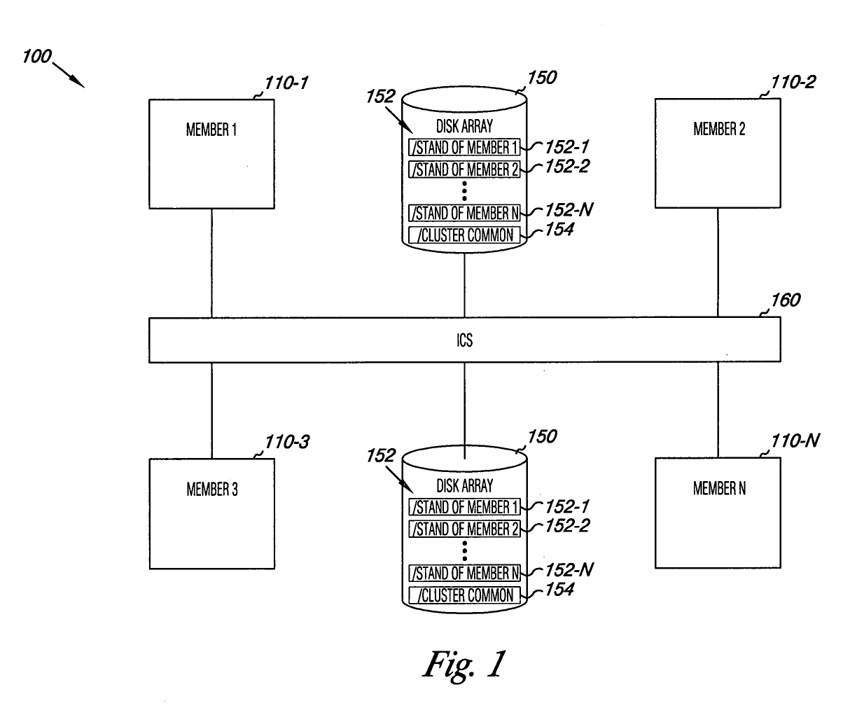

FIG. 1 is a block diagram of a computer cluster system suitable to implement embodiments of the present disclosure. Computer cluster system 100 includes a number of cluster members, 110-1, 110-2 . . . 110-N. The designator “N” is used to indicate that embodiments are not limited to the number of members in a cluster. While four members are shown in FIG. 1, more or fewer cluster members can be present. The cluster members 110-1 to 110-N are able to communicate via an intra-cluster communication service (ICS) 160. Examples of an ICS 160 can include Ethernet, InfiniBand, or networking technologies as are known in the relevant art. Each member, or node, (i.e., 110-1 to 110-N) can be a computing device that includes at least one processor, a memory, and an operating system. Various operating systems are known in the art including Unix, Linux, Windows, etc. Each cluster member has cluster software installed thereon and is configured to be a member of a cluster.

Cluster system 100 also includes one or more shared storage devices, e.g., storage device 150, that are connected to the ICS 160 and can be accessed by the cluster members. Storage device 150 may be a disk array, hard disk, or other storage device as are known in the art. Storage device 150 can contain both member-specific directories 152 and cluster-common directories 154. In the embodiment of FIG. 1, example member-specific directories 152-1, 152-2 . . . 152-N are shown, e.g., “/stand of member 1.” The /stand directory is the name of a member-specific directory as used by the HP-UX operating system. Embodiments, however, are not limited to this example. The /stand directory is considered “member-specific” because each cluster member can have its own /stand directory 152. Thus, member-specific directories, e.g., /stand of member 1, /stand of member 2 . . . /stand of member N, are illustrated in the embodiment of FIG. 1. It is noted that the embodiment of FIG. 1 illustrates that member-specific directories 152-1 to 152-N can exist in either storage device 150; however, as the reader will appreciate, only one copy of each member-specific directory will exist. For example, because “/stand of member 1” 152-1 is a “member-specific” directory, a copy of it does not exist on more than one storage device 150. The member-specific directories 152 generally contain member specific files. For example, a /stand directory can contain the kernel configuration file of a specific member (e.g., /stand/vmunix). Cluster-common directories, e.g., /cluster-common 154, are directories that can be shared by cluster members, i.e., there may be one common directory that may be accessed by a number of the members 110-1, 110-2 . . . 110-N. Each storage device 150 may contain several specific directories 152 and several common directories 154. For example, each storage device 150 can include the /stand directories 152 of various cluster members and/or cluster-common directories 154.

As mentioned above, the kernel layer of a computer system manages the set of processes that are running on the system by ensuring that each process is provided with processor and memory resources at the appropriate time. A process refers to a running program, or application, having a state and which may have an input and output. The kernel provides a set of services that allow processes to interact with the kernel and to simplify the work of an application writer. The kernel's set of services is expressed in a set of kernel modules. A module is a self contained set of instructions designed to handle particular tasks within a larger program. Kernel modules can be compiled and subsequently linked together to form a kernel. Other types of modules can be compiled and subsequently linked together to form other types of programs as well. As used herein an operating system of a computer system can include a type of Unix, Linux, Windows, and/or Mac operating system, etc.

Cluster-capable commands are commands that can be executed on one or more targeted members of a cluster from a remote cluster node. Therefore, as used herein cluster-capable KC (kernel configuration) commands refers to kernel configuration commands that can be invoked from a single node to effect KC changes on some/all members of a cluster. For simplicity, the term KC command will refer to cluster-capable KC commands throughout the present disclosure, unless otherwise indicated. KC commands are also referred to as KC tools. The HP-UX operating system uses several KC tools, e.g., kconfig, kcmodule, and kctune; however, embodiments are not limited to an HP-UX environment.

The kconfig tool is used to manage whole kernel configurations. It allows configurations to be saved, loaded, copied, renamed, deleted, exported, imported, etc. It can also list existing saved configurations and give details about them.

The kcmodule tool is used to manage kernel modules. Kernel modules can be device drivers, kernel subsystems, or other bodies of kernel code. Each module can have various module states including unused, static (linked into the kernel and unable to be changed without rebuilding and rebooting), and/or dynamic (which can include both “loaded”, i.e., the module is dynamically loaded into the kernel, and “auto”, i.e., the module will be dynamically loaded into the kernel when it is first needed, but has not been yet). That is, each module can be unused, statically bound, e.g., linked into the kernel, or dynamically loaded. These states may be identified as the states describing how the module will be used as of the next system boot and/or how the module is currently being used in the running kernel configuration. Kcmodule will display or change the state of any module in the currently running kernel configuration or a saved configuration.

Kctune is a tool used to manage kernel tunable parameters. As mentioned above, tunable values are used for controlling allocation of system resources and tuning aspects of kernel performance. Kctune will display or change the value of any tunable parameter in the currently running configuration or a saved configuration.

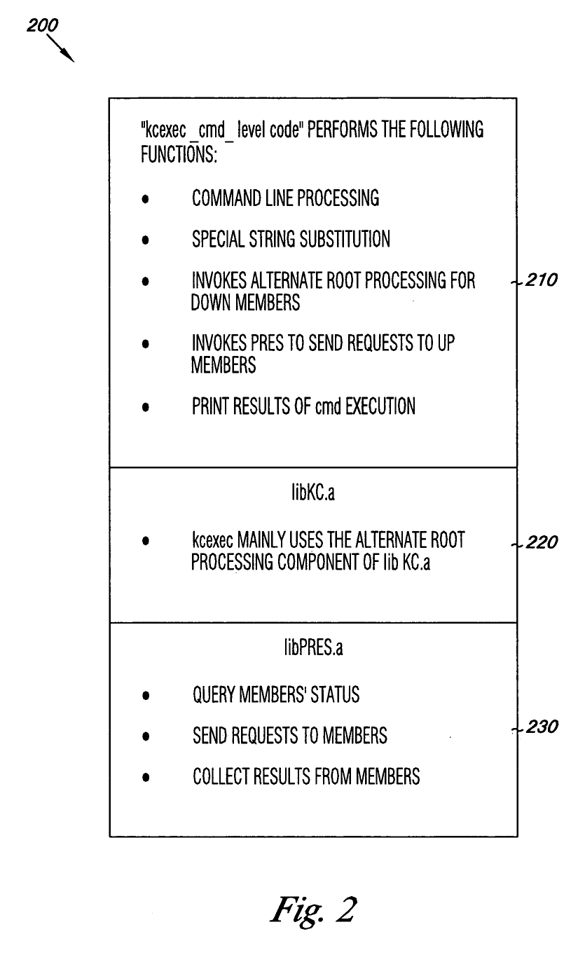

FIG. 2 illustrates an embodiment of code functionality for a kcexec tool according to an embodiment of the present disclosure. FIG. 2 represents command level code in a binary architecture 200. The binary architecture of FIG. 2 illustrates a series of regions of code storable in memory and executable by a processor to perform various functions as described next. As indicated earlier, embodiments of the present disclosure employ a remote command infrastructure provided by the cluster infrastructure encapsulated in a KC library to invoke commands to make changes to targeted cluster members regardless of whether the members are up or down.

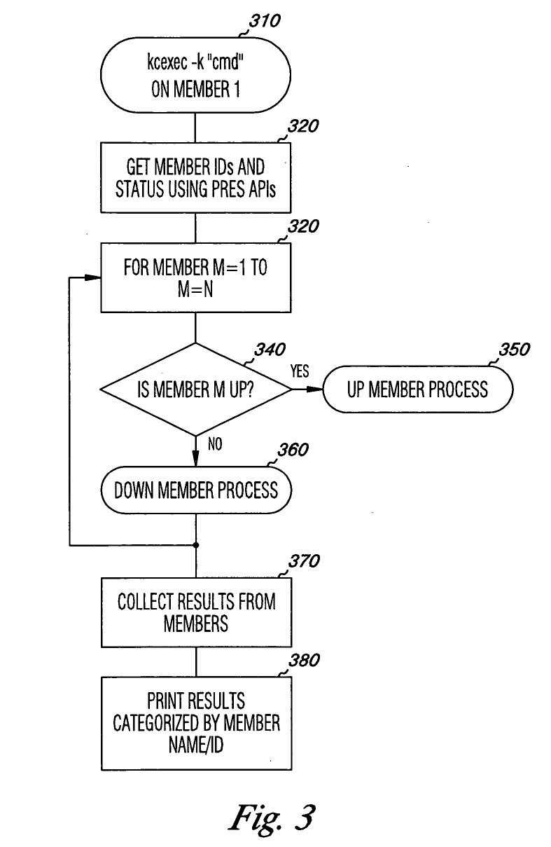

As shown in the embodiment of FIG. 2, region 210 lists the functionality associated with a testing tool, e.g., kcexec. Regions 220 and 230 represent the interaction of the binary architecture with two libraries, libKC.a and libPRES.a, respectively. These are parallel libraries that can be called by tools (e.g., kcexec, kconfig, kctune, etc.) to perform certain tasks. As is understood in the art, a library is a collection of subprograms that are used by independent programs to provide helpful services. As will be discussed in greater detail in connection with FIGS. 3-5, the kcexec tool is a cluster-capable command that can be used to test kernel configuration (KC) commands within a cluster environment. For ease of illustration, the embodiments discussed in connection with FIGS. 1-5 describe a testing tool in the context of the HP-UX operating system and cluster environment. Embodiments, however, are not limited to this example illustration.

As shown in the embodiment of FIG. 2, region 210 of the kcexec tool binary architecture lists various code functionality including, command line processing. Like other cluster-capable KC commands, the command line processing employed by kcexec can take additional flags, or options (e.g., -k and -m). The -k option is used to perform a requested command on all of the members of a cluster, while the -m option is used to perform the requested command on specific members of a cluster. Region 210 also includes the code functionality of special string substitution employed by the kcexec tool. For example, one embodiment of the testing tool includes the strings KC_ENV_MEMBERID, KC_ENV_MEMBERNAME, and KC_ENV_PATH. KC_ENV_MEMBERID and KC_ENV_MEMBERNAME can be located at any position in the string and are replaced with the member identification number (ID) or member name of the targeted cluster member, respectively. This string substitution is useful for broadcasting and gathering as is understood by those of ordinary skill in the art, i.e., it has bidirectional capability and can be used to prevent overwriting of files, etc. An example of the kcexec command level code usage includes: kcexec -k “cp /stand/vmunix /var/adm/vmunix.KC_ENV_MEMBERNAME”. This command causes the /stand/vmunix files of all the cluster members (due to the -k option) to be copied (cp command) into the /var/adm directory. The vmunix file of each member will be suffixed with the corresponding member name (i.e., “vmunix.alpha” for member alpha, “vmunix.beta” for member beta, etc.). As the reader will appreciate, “alpha” and “beta” represent possible member names for cluster nodes. The KC_ENV_PATH string can be placed at the beginning of a kcexec command line string and is replaced with the alternate root directory as necessary.

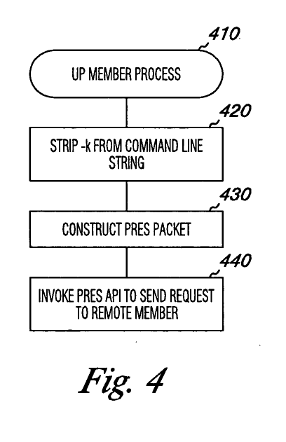

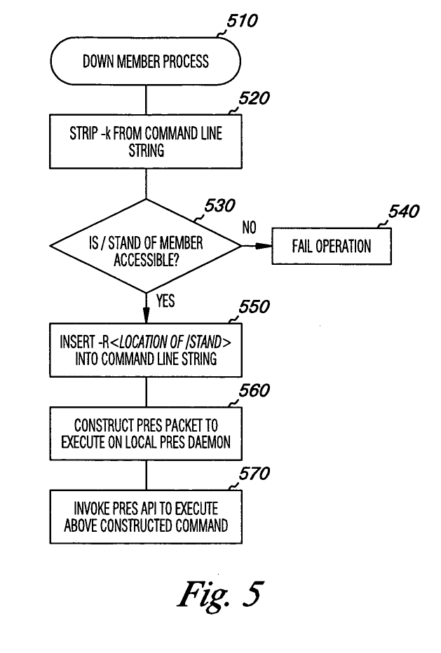

As illustrated in region 210 of the binary architecture of FIG. 2, kcexec command level code includes functionality to invoke alternate root processing for down cluster members and to invoke a parallel remote execution service (PRES) to send requests to up members. The up member processing method is discussed in greater detail in connection with FIG. 4, and the down member processing method is discussed in greater detail in connection with FIG. 5. As used herein, an “up member” refers to a member that has a currently booted operating system, while a “down member” refers to a member that is not currently booted. As is known in the art, booting refers to the process that starts a device's operating system when the device is turned on.

Region 210 of the FIG. 2 binary architecture includes code functionality to print the results of executing a kcexec command on the targeted members. The results can be printed categorized by a member identifier (e.g., a member name or member ID).

Region 220 of the FIG. 2 binary architecture represents the interaction of the binary architecture with a library, libKC.a, which can be called by KC tools, e.g., kcexec. As shown at 220, the kcexec tool mainly uses the alternate root processing component of the libKC.a library. That is, libKC.a is called by kcexec in conjunction with down member processing as will be discussed further in connection with FIG. 5.

Region 230 of the FIG. 2 binary architecture represents the interaction of the binary architecture with a library, libPRES.a, which can be called by KC commands to perform certain functions. Calls to libPRES.a rely on a PRES daemon to be running on each cluster member. As the reader will appreciate a daemon is a Unix program that executes in the background ready to perform an operation when required. Functioning like an extension to the operating system, a daemon is usually an unattended process that is initiated at startup. In the embodiment illustrated in FIG. 2, libPRES.a is called to query a cluster member's status, i.e., is the member up or down, to send requests to remote members, i.e., execute a command, and to collect results from members, i.e., the effect of the command.

FIG. 3 is a flow chart illustrating a method of testing kernel configuration commands according to an embodiment of the present disclosure. FIG. 3 illustrates a method embodiment of the usage of the kcexec testing tool to test KC commands in a cluster environment. As previously mentioned, the kcexec tool can take the options of -k to operate on all cluster members or -m to operate on specific cluster members. For example, a command line such as: “kcexec -m member1, member2 ‘cmd’” would cause command, “cmd”, to be executed on member1and member2 and not on all cluster members. As used herein, “cmd” can be any Unix command, utility, program, etc. along with any parameters to the command to be executed. The kcexec tool, like other cluster-capable KC commands, can operate on both up and down cluster members via a remote command invocation infrastructure.

Cluster-capable KC commands can also operate on a pseudo member of a cluster. A pseudo member is a template used to initialize a new cluster member, i.e., a member joining the cluster. A pseudo member is a directory containing an image of the /stand directory of an HP-UX machine. A pseudo member is created at the time the cluster is created and all cluster-capable commands acting on all members, i.e., those commands utilizing a -k option, act on the pseudo member as well. A pseudo member can be used so that the /stand directory of a new cluster member has the same kernel configuration as the other existing cluster members when it joins the cluster. The down member processing method is used to operate on a pseudo member.

FIG. 3 illustrates a method of using the kcexec tool to execute a command on all cluster members within the cluster environment (as indicated by “-k cmd”), regardless of whether the member is up or down. At block 310, program instructions can execute to begin operating on the cluster members using the kcexec tool. At block 320, kcexec invokes PRES APIs, i.e., sub programs from a library (e.g., libKC.a), to get information about the members (i.e., member names/identifications, status, etc.). For example, at block 320, PRES APIs can be used to determine a member's particular ID and status, i.e., whether the member is an up member, down member, pseudo member, etc.

Block 320 indicates the beginning of a loop to be performed for cluster member “M=1” to member “M=N.” As the reader will appreciate, the loop is performed on each member of the cluster up to the total number of members, N (N is a scalable number, i.e., a cluster can include a variable number of members). Block 340 indicates that the processing method used to operate on a targeted cluster member depends on whether the member has an up or down status, i.e., program instructions can execute to process up members at 350 and down members at 360. At block 370, program instructions execute to invoke a PRES API to collect results of operating on the cluster members, i.e., the effects of running the command on the members. At block 380, program instructions can execute to invoke a PRES API to print the results obtained at 370 and to exit the test.

FIG. 4 illustrates an approach to performing a processing method according to an embodiment of the present disclosure. The method described in FIG. 4 is an up member processing method, i.e., the processing method indicated at 350 that is performed on up members. Program instructions can execute to perform up member processing on an up cluster member by invoking the parallel remote execution service (PRES) infrastructure. At block 420, the -k option is removed from the command line string. Program instructions then execute to construct a PRES packet at 430. The PRES packet includes the command to be executed, the member ID of the member on which the command is to be executed, and a callback handler. Program instructions execute to invoke the callback handler when the command finishes execution, i.e., when the results of command execution are received via the PRES infrastructure. Program instructions can execute to invoke a PRES API to send the request (i.e., execute the command) to the targeted cluster member at 440. As discussed in connection with FIG. 3, kcexec can invoke a PRES API from the libPRES.a library to collect a result of operating on the member and can print the result.

FIG. 5 illustrates an approach to performing a processing method according to an embodiment of the present disclosure. The method described in FIG. 5 is a down member processing method, i.e., the processing method indicated at 360 that is performed on down cluster members. As previously discussed, KC commands can operate on down members or a pseudo member when a pre-condition is met, i.e., when the file system containing the member's kernel configuration information (i.e., the member's /stand directory) is located on a shared disk (e.g., 150) and is mounted at the same path where it would be if the system were booted. When this condition is met, the operation is treated as an alternate root mode operation with the mount path as the alternate root location. That is, program instructions can execute to alter the kernel configuration file, i.e., the vmunix file, of a down member when the /stand/vmunix directory is located on a shared disk. In this way, the configuration changes are effective when the down system boots since it is booting from the alternate root location (i.e., the /stand/vmunix file is located on the shared disk).

To operate on a down cluster member, program instructions can execute to remove the -k option from the kcexec command line string at 520. At block 530 program instructions execute to query whether the /stand directory of the targeted member is accessible, i.e., whether the /stand of the member is located at a shared location (e.g., disk 150). If the /stand directory of the down member is not accessible, a fail operation occurs at 540 such that the down member processing for the member terminates. If the /stand directory of the down member is accessible, program instructions execute to insert a -R option followed by the location of the /stand directory of the member into the command line string. The -R option is used to indicate the alternate location of the root directory, i.e., the location of the /stand for the down member on shared disk 150. Program instructions then execute to construct a PRES packet at 560. The PRES packet includes the command to be executed, the member ID of the member on which the command is to be executed, and a callback handler. Program instructions execute to invoke the callback handler when the command finishes execution, i.e., when the results of command execution are received via the PRES infrastructure. Program instructions can execute to invoke a PRES API to send the request (i.e., execute the command) to the targeted cluster member at 570. As discussed in connection with FIG. 3, kcexec can invoke a PRES API from the libPRES.a library to collect a result of operating on the member and can print the result.

As discussed above, the kcexec tool can execute any Unix command on targeted cluster members by linking to kernel configuration libraries (i.e., libKC.a and libPRES.a) to perform the up member processing 410 on up members and down member processing 510 on down members or a pseudo member. As one of ordinary skill in the art will appreciate, the kcexec tool allows an existing test suite to become cluster-capable, i.e., kcexec allows existing tests to be re-used within a cluster environment. A test suite refers to a group of related tests that can be grouped together and may cooperate with each other, as is understood in the art. The kcexec tool allows for control over the steps within a test case, i.e., the steps of setting-up (saving), running a KC command on targeted nodes, and restoring the system state of the targeted nodes. Saving and restoring can be accomplished with kcexec because it can invoke any setup and restore operations that may be required (e.g., calls to Unix commands including cp, mv, touch, rm, symlink, etc.).

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the invention. It is to be understood that the above description has been made in an illustrative fashion, and not a restrictive one. Combination of the above embodiments, and other embodiments not specifically described herein will be apparent to those of skill in the art upon reviewing the above description. The scope of the various embodiments of the invention includes any other applications in which the above structures and methods are used. Therefore, the scope of various embodiments of the invention should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A method for testing commands within a cluster environment, comprising:
saving an original system state of two or more targeted cluster members by invoking a first operation with a testing tool; and
automatically testing, from a single node, the system states of the two or more targeted cluster members on which a command is run.

2. The method of claim 1, wherein the method includes running the command on a targeted up cluster member by performing an up member processing method and on a targeted down cluster member and a pseudo cluster member by performing a down member processing method.

3. The method of claim 2, wherein:
saving the original system state includes saving the original system state of the targeted up members and the targeted down members; and
wherein the saving of the system state of the targeted up members includes performing the up member processing method, and the saving of the system state of the targeted down members includes performing the down member processing method.

4. The method of claim 3, wherein the command is a kernel configuration command.

5. The method of claim 4, wherein saving the original system state of the two or more targeted members includes saving a kernel configuration file, and wherein invoking the first operation with the tool to save the original system state includes querying the two or more targeted cluster members of their status.

6. The method of claim 5, wherein performing the up member processing method includes invoking a remote command invocation infrastructure to perform the operation on the targeted up cluster member.

7. The method of claim 6, wherein performing the down member processing method includes performing an alternate root mode operation when:
a file system that contains the kernel configuration file of the down member resides at a shared location; and
the kernel configuration file is mounted at a path at which it would be mounted if the down member were booted.

8. The method of claim 7, wherein the method includes restoring the original system states of the two or more targeted cluster members by invoking a second operation with the testing tool, and wherein the restoring includes:
restoring the original system state of the targeted up members and the targeted down members; and
wherein the restoring of the system state of the targeted up members includes performing the up member processing method and the restoring of the system state of the targeted down members includes performing the down member processing method.

9. The method of claim 8, wherein testing the system states includes collecting a result from the targeted members and printing the result from the targeted members.

10. The method of claim 9, wherein printing the result further includes printing the result categorized by a member.

11. The method of claim 8, wherein invoking the first operation and the second operation with the testing tool includes invoking at least one operation selected from the group, including:
copy;
move;
remove; and
create symbolic link.

12. A computer readable medium having a program to cause a device to perform a method, comprising:
invoking a save operation with a testing tool to save a kernel configuration file of a number of cluster members;
testing a kernel configuration command; and
invoking a restore operation with the testing tool to restore the kernel configuration file of the number of cluster members.

13. The medium of claim 12, wherein invoking the save operation with the testing tool includes using a remote command invocation infrastructure to invoke the save operation on the number of cluster members.

14. The medium of claim 13, wherein invoking the restore operation with the testing tool includes using the remote command invocation infrastructure to invoke the save operation on the number of cluster members.

15. The medium of claim 14, wherein the remote command invocation infrastructure can invoke the operations on up cluster members, down cluster members, and a pseudo cluster member.

16. The medium of claim 15, wherein using the remote command invocation infrastructure includes:
querying the number of cluster members to determine their status;
performing an up member processing method on the up cluster members; and
performing a down member processing on the down cluster members.

17. The medium of claim 16, wherein performing the down member processing method includes effecting an operation on the down members by using an alternate root mode operation when:
a file system that contains the down member's kernel configuration file resides at a shared location; and
the file is mounted at a path at which it would be mounted if the down member were booted.

18. The medium of claim 16, wherein querying the number of cluster members includes invoking a parallel remote execution service (PRES) application programming interface (API).

19. A kernel configuration command testing tool, comprising:
a processor;
a memory coupled to the processor; and
program instructions provided to the memory and executable by the processor to test kernel configuration commands in a cluster environment, wherein the instructions are executable to:
employ a remote command invocation infrastructure to invoke a first operation on two or more remote cluster members;
test a kernel configuration command; and
employ the remote command invocation infrastructure to invoke a second operation on the two or more remote cluster members.

20. The tool of claim 19, wherein the first operation is an operation to save a system state of the two or more remote members, and wherein the second operation is an operation to restore the system state of the two or more remote members.

21. The tool of claim 20, wherein the system state of the two or more members is a kernel configuration state.

22. The tool of claim 21, wherein the remote command invocation infrastructure can invoke the first and second operations of up cluster members and down cluster members.

23. A system, comprising:
a testing tool;
a kernel configuration accessible by the testing tool;
means for automatically saving and restoring a system state while testing a kernel configuration command within a cluster environment by using a remote command invocation infrastructure.
